(19) United States
(12) Patent Application Publication
(10) Pub. No.: US 2026/0011023 A1
(43) Pub. Date: Jan. 8, 2026

(54) ELECTRONIC APPARATUS FOR IMAGE PROCESSING OF GHOST OBJECT IN LIVE VIEW IMAGE AND CONTROL METHOD THEREOF

(71) Applicant: SAMSUNG ELECTRONICS CO., LTD., Suwon-si (KR)

(72) Inventors: Golam RABBI, Dhaka (BD); Tarikul ISLAM, Dhaka (BD); Zubair Azami BADHON, Dhaka (BD); Muntasir Kabir CHOWDHURY, Dhaka (BD)

(73) Assignee: SAMSUNG ELECTRONICS CO., LTD., Suwon-si (KR)

(21) Appl. No.: 19/211,965

(22) Filed: May 19, 2025

Related U.S. Application Data
(63) Continuation of application No. PCT/KR2025/004069, filed on Mar. 28, 2025.

(30) Foreign Application Priority Data
Jul. 3, 2024 (KR) 10-2024-0087628

(51) Int. Cl. G06T 7/254; G06F 3/14; G06V 10/60

(52) U.S. Cl. CPC G06T 7/254; G06F 3/14; G06V 10/60

(57) ABSTRACT

An electronic apparatus includes a camera, a display, a sensor, and at least one processor configured to: control the display to display a plurality of first live view images obtained through the camera; identify a first area and a second area, each having a predetermined brightness or greater, in the plurality of first live view images; identify one area from among the first area and the second area as an area subject to removal by comparing a first motion of the first area and a second motion of the second area with a third motion of the electronic apparatus obtained through the sensor; perform an image processing on an area corresponding to the area subject to removal in a plurality of second live view images, obtained after the plurality of first live view images; and control the display to display the image processed plurality of second live view images.

### CROSS-REFERENCE TO RELATED APPLICATION(S)

This application is a continuation of International Application No. PCT/KR2025/004069, filed on Mar. 28, 2025, in the Korean Intellectual Property Receiving Office, which claims priority to Korean Patent Application No. 10-2024-0087628, filed on Jul. 3, 2024, in the Korean Intellectual Property Office, the disclosures of which are incorporated by reference herein in their entireties.

### BACKGROUND

### 1. Field

One or more example embodiments of the disclosure relate to an electronic apparatus and a control method thereof, and more particularly to an electronic apparatus that performs image processing of a ghost object in a live view image and a control method thereof.

### 2. Description of Related Art

With developments in electronic apparatuses and multimedia technology, capturing of photos and videos are carried out by using smartphones. Specifically, smartphone cameras are capable of capturing photos and/or videos in a wide range of scenarios and conditions using artificial intelligence models and high-performance processors, and quality the photos and/or videos may be further improved through a one click post processing using an artificial intelligence model(s).

However, a lens flare phenomenon such as camera ghosting or lens ghosting may occur in a smartphone, and such phenomenon may lower quality of a result product, and require a detailed post processing to manually remove a ghost object.

### SUMMARY

According to an aspect of an example embodiment of the disclosure, provided is an electronic apparatus including: a camera, a display, a sensor, and at least one processor configured to: control the display to display a plurality of first live view images obtained through the camera; identify a first area and a second area, each having a predetermined brightness or greater, in the plurality of first live view images; identify one area from among the first area and the second area as an area subject to removal by comparing a first motion of the first area and a second motion of the second area with a third motion of the electronic apparatus obtained through the sensor; perform an image processing on an area corresponding to the area subject to removal in a plurality of second live view images, obtained after the plurality of first live view images through the camera; and control the display to display the image processed plurality of second live view images.

According to an aspect of an example embodiment of the disclosure, provided is a method of controlling an electronic apparatus including: displaying a plurality of first live view images obtained through a camera included in the electronic apparatus; identifying a first area and a second area, each having a predetermined brightness or greater, in the plurality of first live view images; identifying one area from among the first area and the second area as an area subject to removal by comparing a first motion of the first area and a second motion of the second area with a third motion of the electronic apparatus; performing an image processing on an area corresponding to the area subject to removal from a plurality of second live view images obtained after the plurality of first live view images; and displaying the image processed plurality of second live view images.

### BRIEF DESCRIPTION OF THE DRAWINGS

The above and other aspects, features, and advantages of the disclosure will be more clearly understood from the following detailed description, taken in conjunction with the accompanying drawings, in which:

FIG. 1A to FIG. 1C are diagrams illustrating examples of camera ghosting;

FIG. 2 is a block diagram illustrating a configuration of an electronic apparatus according to an example embodiment of the disclosure;

FIG. 3 is a block diagram illustrating a detailed configuration of an electronic apparatus according to an example embodiment of the disclosure;

FIG. 4 is a diagram illustrating a motion of a ghost object based on a motion of an electronic apparatus according to an example embodiment of the disclosure;

FIG. 5 to FIG. 10 are diagrams illustrating a method for tracking a ghost area according to example embodiments of the disclosure;

FIG. 11 is a diagram illustrating a method for identifying an additional ghost area according to an example embodiment of the disclosure;

FIG. 12 is a diagram illustrating an operation of a ghost area being removed according to an example embodiment of the disclosure; and

FIG. 13 is a flowchart illustrating a control method of an electronic apparatus according to an example embodiment of the disclosure.

### DETAILED DESCRIPTION

Hereinafter, some example embodiments are illustrated in the drawings and are described in detail in the detailed description. However, it is to be understood that the example embodiments of the present disclosure may be diversely modified. In other words, the present disclosure is not limited to a specific example embodiment, but includes all modifications, equivalents, and substitutions without departing from the scope and spirit of the present disclosure. Also, well-known functions or constructions are not described in detail since they may obscure the disclosure with unnecessary detail.

An object of the disclosure is in providing an electronic apparatus that identifies a ghost object in a live view image, and provides the live view image in which the identified ghost object is removed and a control method thereof.

Various embodiments of the disclosure and terms used herein are not intended to limit the technical features described in the disclosure to specific embodiments, and it is to be understood as including various modifications, equivalents, or alternatives of the corresponding embodiments.

With respect to the description of the drawings, like reference numerals may be used for similar or related elements.

A singular form of a noun corresponding to an item may include one item or a plurality of items, unless otherwise specified explicitly in the related context.

In the disclosure, phrases such as “A or B”, “at least one of A and B”, “at least one of A or B”, “at least one from among A or B,” “A, B, or C”, “at least one of A, B, and C”, and “at least one of A, B, or C” may respectively include any one of the items or any one of possible combinations of the items listed together with the relevant phrase from among the phrases. For example, an expression, “at least one of A and B” should be understood as including only A, only B, or both A and B.

Terms such as “1st”, “2nd”, or “first” or “second” may be used to simply distinguish a relevant element from another relevant element, and not limit the relevant elements in other aspects (e.g., importance or order).

When a certain (e.g., a first) element is indicated as being “coupled with/to” or “connected to” another (e.g., a second) element, together with or without terms such as “operatively” or “communicatively”, it may be understood as the certain element being coupled with/to the another element directly (e.g., via wire), wirelessly, or through a third element.

Terms such as “include” or “have” are used herein to designate a presence of a characteristic, number, step, operation, element, component, or a combination thereof, and not to preclude a presence or a possibility of adding one or more of other characteristics, numbers, steps, operations, elements, components or a combination thereof.

When a certain element is described as “coupled”, “combined”, “supported”, or “contacted” with another element, the above may include not only the elements being directly coupled, combined, supported, or contacted, but also being indirectly coupled, combined, supported, or contacted through the third element.

When the certain element is described as positioned “on” another element, the above may include not only the certain element being contacted to another element, but also other element being present between the two elements.

The term “and/or” may include a combination of a plurality of related elements described or any element from among the plurality of related elements described.

Working effect and embodiments of the disclosure will be described below taking into reference the accompanied drawings.

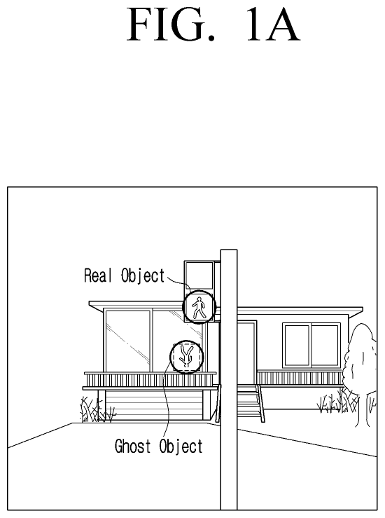

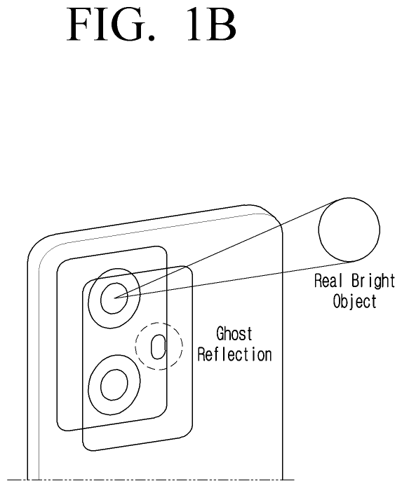

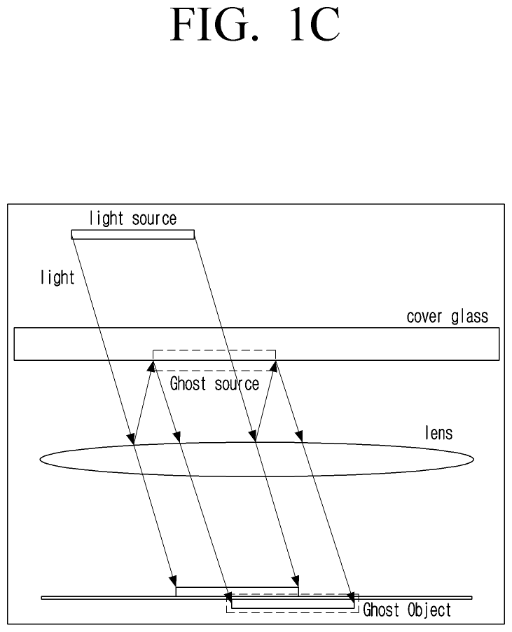

FIG. 1A to FIG. 1C are diagrams illustrating examples of camera ghosting.

Camera ghosting is a flare type that is generated as light or a ray from a bright object is repeatedly reflected from a lens surface, and may be referred to as lens ghosting. For example, in a live view image in FIG. 1A, a lit-up traffic light (a real object) and a ghost object of a similar form with the lit-up traffic light may be included. As shown in FIG. 1B, the ghost object included in the live view image may be generated by rays at a surface of a cover glass that comes in contact with the lens.

Generation of the ghost object will be described in greater detail through FIG. 1C. First, if rays emitted from a bright light source reaches the lens, a portion of the rays may reach an image sensor by passing through the lens and a portion of the rays may be reflected by the lens. The reflected rays may reach the cover glass, and move toward the lens by being reflected again by the cover glass. A portion from among the rays reflected by the cover glass may reach the image sensor by passing through the lens. Accordingly, the image sensor may sense two objects of a similar form. Here, one object from among the two objects of a similar form may be due to the rays from the bright light source, and a remaining object may be due to rays from a ghost source formed at the cover glass as the rays from the bright light source are reflected two or more times.

The ghost object may be removed manually through post-processing of an image. For example, a smartphone may remove a ghost object selected by a user through a neural network model, and fill an area of the removed ghost object with a related background. However, this process requires a selection by the user, and therefore may be a problem if the above process is skipped without the selection by the user.

In addition, if the light source is in plurality, identifying a plurality of ghost objects corresponding to a plurality of light sources may be difficult, and a technique for removing ghost objects may be applied to only individual relevant frames and not to a video.

In addition, because a ghost object is an optical phenomenon, the image sensor may not identify the ghost object in a live view image or a video. That is, there is a need for a method to automatically detect a ghost object and/or remove the ghost object in real-time.

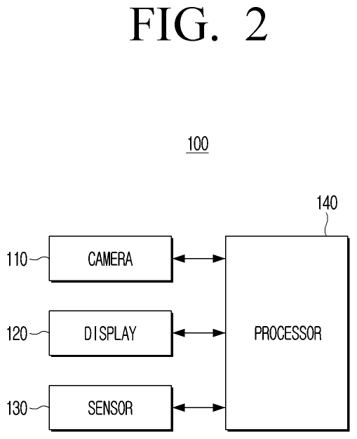

FIG. 2 is a block diagram illustrating a configuration of an electronic apparatus 100 according to an embodiment of the disclosure.

The electronic apparatus 100 may be an apparatus that provides an image captured through a camera as a live view image, and may be implemented as a smartphone, a tablet personal computer (PC), a digital camera, a television (TV), a desktop PC, a notebook, and the like. Specifically, the electronic apparatus 100 may be an apparatus that includes a camera, removes a ghost object from the image captured through the camera, and provides the image in which the ghost object is removed as the live view image.

However, the embodiment is not limited thereto, and the electronic apparatus 100 may be any apparatus that may provide an image captured through a camera as a live view image. Alternatively, the electronic apparatus 100 may receive an image from an external camera and provide the received image as a live view image. Alternatively, the electronic apparatus 100 may be an apparatus that provides an image captured through a camera to an external display device as a live view image.

Referring to FIG. 2, the electronic apparatus 100 may include a camera 110, a display 120, a sensor 130, and a processor 140. However, the embodiment is not limited thereto, and the electronic apparatus 100 may be implemented in a form in which at least a portion of the above elements is omitted and/or an additional element is added.

The camera 110 may be configured to capture a still image and/or a moving image. The camera 110 may capture a still image at a specific time-point, but may also capture still images consecutively.

The camera 110 may include a lens, a shutter, an aperture, a solid-state imaging device, an Analog Front End (AFE), and a Timing Generator (TG). In addition, the camera 110 may further include a cover glass that comes in contact with the lens. The shutter may be configured to adjust time during which light reflected from a subject enters the camera 110, and the aperture may be configured to adjust an amount of light incident to the lens by mechanically increasing or decreasing a size of an opening part through which light enters. The solid-state imaging device may be configured to output, based on light reflected from the subject being accumulated as photo charge, an image generated by the photo charge as an electric signal. The TG may be configured to output a timing signal for reading out pixel data of the solid-state imaging device, and the AFE may be configured to digitalize the electric signal output from the solid-state imaging device by sampling.

The display 120 may be configured to display content, and implemented as a display of various forms such as, for example, and without limitation, a liquid crystal display (LCD), an organic light emitting diode (OLED) display, and a plasma display panel (PDP), and the like. In the display 120, a driving circuitry, which may be implemented in a form of an amorphous silicon (a-si) thin film transistor (TFT), a low temperature poly silicon (LTPS) TFT, an organic TFT (OTFT), and the like, a backlight unit, and the like may be included. The display 120 may be implemented as a touch screen coupled with a touch sensor, a flexible display, a three-dimensional (3D) display, and the like.

The sensor 130 may obtain motion information of the electronic apparatus 100 through at least one sensor. For example, the sensor 130 may include at least one from among a gyro sensor, an acceleration sensor, or a magnetic field sensor, and the processor 140 may obtain motion information of the electronic apparatus 100 based on information received from one or more sensors included in the sensor 130.

The gyro sensor may be a sensor configured to detect a rotation angle of the electronic apparatus 100 by measuring an angular velocity, and may measure a change in an orientation of an object based on maintaining a certain direction that is initially set with high accuracy regardless of a rotation of the Earth. The gyro sensor may be referred to as a Gyroscope, and may be implemented in a mechanical manner or an optical manner using light.

The acceleration sensor may be a sensor configured to measure an acceleration of the electronic apparatus 100 or a strength of an impact, and may be referred to as an accelerometer. The acceleration sensor may detect dynamic force such as acceleration, vibration, and impact, and may be implemented as an inertial type, a gyro type, a silicon semiconductor type, and the like. That is, the acceleration sensor may be a sensor that senses a degree to which the electronic apparatus 100 is tilted by using gravitational acceleration, and may be generally formed of a two-axis or three-axis fluxgate.

The magnetic field sensor may generally refer to a sensor that measures a strength and a direction of magnetism of the Earth, but in a broader sense, include a sensor that measures a strength of magnetization of an object, and may be referred to as a magnetometer. The magnetic field sensor may be implemented to measure a direction to which a magnet moves by hanging a magnet horizontally in a magnetic field, and/or measures a strength of the magnetic field by rotating a coil in the magnetic field and measuring an induced electromotive force that is generated in the coils.

The processor 140 may obtain motion information of the electronic apparatus 100 by using one or more of the sensors as described above. For example, the processor 140 may obtain movement of the electronic apparatus 100 as information on a three-dimensional space. Alternatively, the processor 140 may obtain the movement of the electronic apparatus 100 as information on the three-dimensional space, and obtain information on a two-dimensional space by projecting the information on the three-dimensional space to the two-dimensional space.

In the above, the sensor 130 has been described as including at least one from among the gyro sensor, the acceleration sensor, or the magnetic field sensor for convenience of description. However, the embodiment is not limited thereto, and the sensor 130 may be any sensor so long as information obtained by the sensor may be used to obtain the motion information of the electronic apparatus 100.

The processor 140 may control an overall operation of the electronic apparatus 100. Specifically, the processor 140 may control the overall operation of the electronic apparatus 100 by being connected with each configuration of the electronic apparatus 100. For example, the processor 140 may control an operation of the electronic apparatus 100 by being connected with configurations such as, for example, and without limitation, the camera 110, the display 120, and the sensor 130.

The processor 140 may be implemented as one or more processors. The one or more processors may include, for example but not limited to, one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors may control one or more from among elements of the electronic apparatus 100, and perform an operation associated with communication and/or data processing. The one or more processors may execute one or more programs or instructions stored in a memory. For example, the one or more processors may perform, by executing one or more instructions stored in the memory, a method according to an embodiment of the disclosure.

When a method according to an embodiment of the disclosure includes a plurality of operations, the plurality of operations may be performed by one processor, or performed by a plurality of processors. For example, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor). For example, a process of quantizing a neural network model according to an embodiment of the disclosure may be performed by the generic-purpose processor, and a process of training or inferring the quantized neural network model may be performed by the artificial intelligence dedicated processor.

The one or more processors may be implemented as a single core processor that includes one core, or implemented as one or more multicore processors that include a plurality of cores (e.g., a homogeneous multicore or a heterogeneous multicore). If the one or more processors are implemented as a multicore processor, each of the plurality of cores included in the multicore processor may include a memory inside the processor such as a cache memory and an on-chip memory, and a common cache shared by the plurality of cores may be included in the multicore processor. In addition, each of the plurality of cores (or a portion from among the plurality of cores) included in the multicore processor may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processor. For example, when a first operation, a second operation, and a third operation are performed by a method according to an embodiment, the first operation, the second operation, and the third operation may all be performed by a first core included in the multicore processor, or the first operation and the second operation may be performed by the first core included in the multicore processor and the third operation may be performed by a second core included in the multicore processor.

In the embodiments of the disclosure, the one or more processors may refer to a system on chip (SoC), a single core processor, or a multicore processor in which the one or more processors and other electronic components are integrated or a core included in the single core processor or the multicore processor, and the core herein may be implemented as the CPU, the GPU, the APU, the MIC, the DSP, the NPU, the hardware accelerator, the machine learning accelerator, or the like, but the embodiments of the disclosure are not limited to thereto. However, for convenience of description, an operation of the electronic apparatus 100 will be described below using the expression ‘processor 140.’

The processor 140 may display a plurality of first live view images obtained through the camera 110 through the display 120, and identify a first area and a second area of a predetermined brightness or more in the plurality of first live view images.

For example, the processor 140 may display a plurality of first live view images obtained through the camera 110 through the display 120, identify a first area and a second area of a predetermined brightness or more in a first image from among the plurality of first live view images, and track the identified first area and the second area from at least one second image following the first image from among the plurality of first live view images.

The processor 140 may identify an area subject to removal from among the first area and the second area based on a form of at least one of the first area and the second area. For example, the processor 140 may compare, based on the first area and the second area of the predetermined brightness or more being identified in the plurality of first live view images, a form of the first area and a form of the second area and identify that the first area and the second area are related if a degree of similarity is less than a threshold value. In an example, the processor 140 may identify one from among the first area and the second area as a light source, and identify the remaining one as the ghost object, based on a determination that a degree of similarity between a form of the first area and a form of the second area is less than the threshold value.

The processor 140 may identify a first motion of the first area and a second motion of the second area by tracking the first area and the second area in the plurality of first live view images. In addition, the processor 140 may obtain a third motion of the electronic apparatus through the sensor 130.

The processor 140 may identify one from among the first area and the second area as an area subject to removal by comparing the first motion and the second motion with the third motion. For example, the processor 140 may identify, from among the first motion and the second motion, an area of which a direction of a motion is same as the third motion and/or of which a movement distance by a time period is proportionate with that of the third motion, as the area subject to removal.

Alternatively, the processor 140 may identify a first distance to a first object that corresponds to the first area and a second distance to a second object that corresponds to the second area, and identify, from among the first distance and the second distance, the area subject to removal by taking into further consideration a distance between a minimum distance from the lens to the cover glass and a maximum distance from the lens to the cover glass. For example, one object from among the first object and the second object may be a light source outside of the electronic apparatus 100, and the other object from among the first object and the second object may be an area where light emitted from the light source has reached the cover glass after being reflected by the lens, and the light that reached the cover glass after being reflected by the lens may reach the lens by being reflected by the cover glass, and the processor 140 may identify the other object from among the first object and the second object as the area subject to removal.

Alternatively, the processor 140 may identify the area subject to removal by taking into further consideration a brightness of the first area and a brightness of the second area. For example, the processor 140 may identify, from among the first motion and the second motion, an area of which a direction of a motion is same as the third motion and/or of which a movement distance by a time period is proportionate with that of the third motion, and an area with a relatively low brightness as the area subject to removal. Because the ghost source is generated on the cover glass as the rays of the light source are reflected several times, the brightness corresponding to the ghost source may be lower than the brightness of the light source.

The processor 140 may change the method for identifying the area subject to removal based on at least one from among a hardware performance or resources of the electronic apparatus 100. For example, the processor 140 may identify, based on the hardware performance of the electronic apparatus 100 being high and there being plenty of resources, the area subject to removal by performing all or some of the above-mentioned motion comparison, distance (movement distance and/or distance to the object) comparison, and brightness comparison. Alternatively, the processor 140 may identify, based on the hardware performance of the electronic apparatus 100 being low and the resources being limited, the area subject to removal by comparing only a moving direction in each area and a moving direction of the electronic apparatus 100. In addition, the processor 140 may change, after identifying the area subject to removal by comparing only the moving direction in each area and the moving direction of the electronic apparatus 100, the area subject to removal by sequentially performing comparisons on whether it is proportionate between motions, on distances, on the brightness, and/or the like.

The third motion may be three-dimensional motion data, and the processor 140 may convert the third motion to two-dimensional motion data, and identify one from among the first area and the second area as the area subject to removal by comparing the first motion and the second motion with the converted third motion.

The processor 140 may perform image processing on an area corresponding to the area subject to removal from a plurality of second live view images following the plurality of first live view images, and display the image processed plurality of second live view images through the display 120.

For example, the processor 140 may perform image processing on an area corresponding to the area subject to removal in the plurality of second live view images following the plurality of first live view images based on at least one surrounding pixel value of the area corresponding to the area subject to removal. In this case, the plurality of second live view images may be image processed as if the ghost object included in the area subject to removal was never present.

However, the embodiment is not limited thereto, and the processor 140 may perform image processing on the area subject to removal using a neural network model. For example, the processor 140 may apply a generative neural network model to the area subject to removal and perform image processing of the plurality of second live view images as if the ghost object was never present.

The processor 140 may determine a position of an area corresponding to the area subject to removal in the plurality of second live view images based on the third motion. That is, the processor 140 may determine, based on the area subject to removal being identified, the position of the area subject to removal in a following live view image based on the third motion of the electronic apparatus 100, and omit an operation of identifying an area of a predetermined brightness or more and an operation of identifying the area subject to removal in the plurality of second live view images. The position of the area corresponding to the area subject to removal in the plurality of second live view images may be changed from the position of the area subject to removal (the first area or the second area) determined in the plurality of first live view images due to the third motion of the electronic apparatus 100.

However, the embodiment is not limited thereto, and the processor 140 may perform, based on the area subject to removal being identified, an operation of further identifying an area of a predetermined brightness or more. The processor 140 may further identify the area subject to removal if there is additional identification, and omit the operation of identifying the area subject to removal if there is no additional identification. Alternatively, the processor 140 may determine the position of the area corresponding to the area subject to removal in the plurality of second live view images based on the third motion, and identify, based on the determined position being outside of the plurality of second live view images, a third area of a predetermined brightness or more in the plurality of second live view images. The processor 140 may further identify the area subject to removal based on the third area being identified.

The electronic apparatus 100 may further include a user interface and a memory, and the processor 140 may perform, based on a capture command being received through the user interface, image processing on an area corresponding to the area subject to removal from a live view image corresponding to the capture command, and store the image processed live view image in the memory.

Through the operation as described above, the problem of the ghost object being displayed in the live view image or included in a captured image may be solved.

A function associated with artificial intelligence according to the disclosure may be operated through the processor 140 and the memory.

The processor 140 may be formed as one or a plurality of processors. The one or plurality of processors may be a generic-purpose processor such as the CPU, the AP, the DSP, a graphics dedicated processor such as the GPU, a vision processing unit (VPU), or an artificial intelligence dedicated processor such as the NPU.

The one or plurality of processors may control for input data to be processed according to a pre-defined operation rule and/or an artificial intelligence model stored in the memory. Alternatively, if the one or plurality of processors is the artificial intelligence dedicated processor, the artificial intelligence dedicated processor may be designed to a hardware structure specializing in the processing of a specific artificial intelligence model. The pre-defined operation rule and/or the artificial intelligence model may be characterized by being created through learning.

Here, being created through learning may refer to the pre-defined operation rule or the artificial intelligence model set to perform a desired characteristic (or purpose) being created as a basic artificial intelligence model is trained by a learning algorithm using a plurality of learning data. The learning may be carried out in a machine itself in which the artificial intelligence according to the disclosure is performed, or carried out through a separate server and/or system. Examples of the learning algorithm may include a supervised learning, an unsupervised learning, a semi-supervised learning, and/or a reinforcement learning, but is not limited to the above-described examples.

The artificial intelligence model may be configured of a plurality of neural network layers. Each of the plurality of neural network layers may include a plurality of weight values, and perform a neural network processing through processing between a processing result of a previous layer and the plurality of weight values. The plurality of weight values included in the plurality of neural network layers may be optimized by a learning result of the artificial intelligence model. For example, the plurality of weight values may be updated for a loss value or a cost value obtained by the artificial intelligence model during the learning process to be reduced or minimized.

An artificial neural network may include a Deep Neural Network (DNN), and examples thereof may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Generative Adversarial Network (GAN), a Deep-Q Networks, or the like, but the embodiment is not limited thereto.

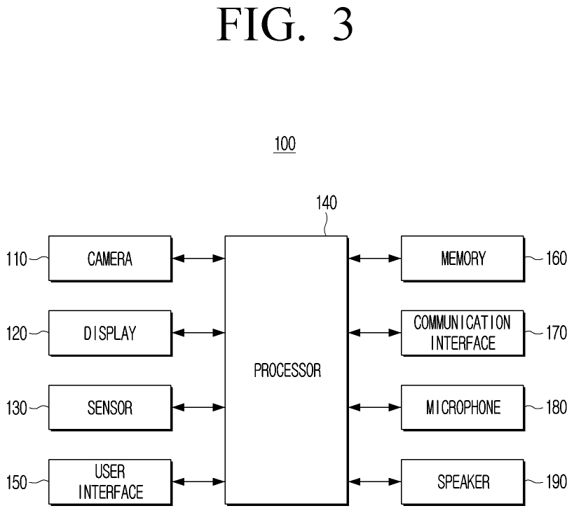

FIG. 3 is a block diagram illustrating a detailed configuration of the electronic apparatus 100 according to an embodiment of the disclosure.

The electronic apparatus 100 may include the camera 110, the display 120, the sensor 130, and the processor 140. In addition, referring to FIG. 3, the electronic apparatus 100 may further include a user interface 150, a memory 160, a communication interface 170, a microphone 180, and a speaker 190. Detailed descriptions of portions that overlap with the elements shown in FIG. 2 from among the elements shown in FIG. 3 will be omitted.

The user interface 150 may be implemented as a button, a touch pad, a mouse, a keyboard, and the like, and/or implemented also as a touch screen capable of performing a display function and an operation input function together therewith. Here, the button may be a button of various types such as a mechanical button, a touch pad, and/or a wheel which may be formed at a random area, e.g., an area at a front surface part or a side surface part, a rear surface part, or the like of an exterior of a main body of the electronic apparatus 100.

The memory 160 may refer to a hardware that stores information such as data in electric and/or magnetic form for the processor 140 and the like to access. To this end, the memory 160 may be implemented as at least one hardware from among a non-volatile memory, a volatile memory, a flash memory, a hard disk drive (HDD) or a solid state drive (SSD), a random access memory (RAM), a read only memory (ROM), and the like.

In the memory 160, at least one instruction related to an operation of the electronic apparatus 100 or the processor 140 may be stored. Here, the instruction may be a code unit that instructs an operation of the electronic apparatus 100 and/or the processor 140, and may be prepared in a machine language which is a language that can be understood by a computer.

The memory 160 may be stored with data which is information of a bit and/or byte unit that may represent a character, a number, an image, and the like. For example, the memory 160 may be stored with a neural network model.

The memory 160 may be accessed by the processor 140 and reading, writing, modifying, deleting, updating, and the like of instructions, an instruction set, and/or data may be performed by the processor 140.

The communication interface 170 may be configured to perform communication with external devices of various types according to communication methods of various types. For example, the electronic apparatus 100 may perform communication with a server through the communication interface 170.

The communication interface 170 may include, for example but not limited to, a Wi-Fi module, a Bluetooth module, an infrared communication module, a wireless communication module, and the like. Here, each communication module may be implemented in at least one hardware chip form.

The Wi-Fi module and the Bluetooth module may perform communication in a Wi-Fi method and a Bluetooth method, respectively. When using the Wi-Fi module or the Bluetooth module, various connection information such as a service set identifier (SSID) and a session key may first be transmitted and received, and after communicatively joining using the same, various information may be transmitted and received. The infrared communication module may perform communication according to an infrared communication (Infrared Data Association (IrDA)) technology that transmits data wirelessly in a short range by using infrared rays present between visible rays and millimeter waves.

The wireless communication module may include at least one communication chip that performs communication according to various wireless communication standards such as, for example but not limited to, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

Alternatively, the communication interface 170 may include a wired communication interface such as, for example, and without limitation, High-Definition Multimedia Interface (HDMI), display port (DP), Thunderbolt, Universal Serial Bus (USB), RGB, D-subminiature (D-SUB), Digital Visual Interface (DVI), and the like.

In addition thereto, the communication interface 170 may include at least one from among wired communication modules that perform communication using a local area network (LAN) module, an Ethernet module, or a pair cable, a coaxial cable or an optical fiber cable, or the like.

The microphone 180 may be configured to receive sound and convert to an audio signal. The microphone 180 may be electrically coupled with the processor 140, and may receive sound under control of the processor 140.

For example, the microphone 180 may be formed as an integrated-type integrated with the electronic apparatus 100 on an upper side direction, a front surface direction, a side surface direction or the like of the electronic apparatus 100. Alternatively, the microphone 180 may be provided in a remote controller, or the like separate from the electronic apparatus 100. In this case, the remote controller may receive sound through the microphone 180, and provide the received sound to the electronic apparatus 100.

The microphone 180 may include various configurations such as a microphone that collects sound in an analog form, an amplifier circuit that amplifies the collected sound, an analog/digital (A/D) converter circuit that samples the amplified sound and converts to a digital signal, a filter circuit that removes noise components from the converted digital signal, and the like.

The microphone 180 may be implemented in a form of a sound sensor, and may be in any form so long as the microphone can collect sound.

The speaker 190 may be an element that outputs not only various audio data processed in the processor 140, but also various notification sounds, voice messages, or the like.

As described above, the electronic apparatus 100 may provide a live view image in which the ghost object is removed by performing image processing on the area subject to removal based on a motion of an area of a predetermined brightness or more and a motion of the electronic apparatus 100.

In addition, because the electronic apparatus 100 may track the area subject to removal based on the motion of the electronic apparatus 100, a ghost object may be removed from the video.

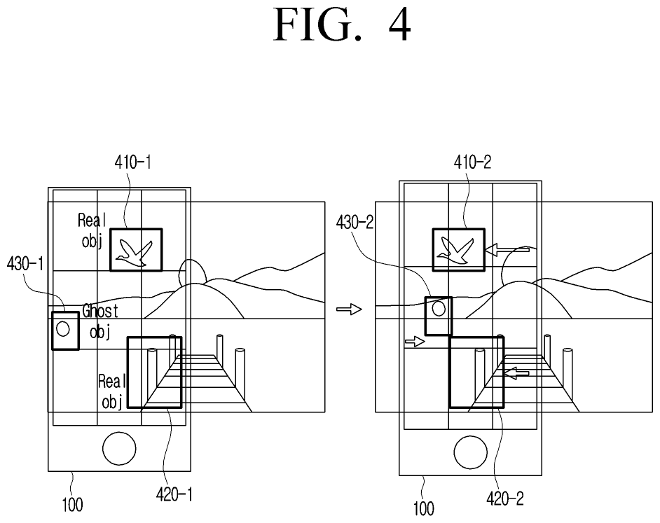

An operation of the electronic apparatus 100 will be described in greater detail below through FIG. 4 to FIG. 12. In FIG. 4 to FIG. 12, individual embodiments will be described for convenience of description. However, the individual embodiments of FIG. 4 to FIG. 12 may be implemented in any combined state.

FIG. 4 is a diagram illustrating a motion of a ghost object based on a motion of an electronic apparatus according to an embodiment of the disclosure.

As shown in FIG. 4, if the electronic apparatus 100 moves to a right side, an actual (or real) object at a position 410-1 and an actual object at a position 420-1 in the live view image may move to a position 410-2 and a position 420-2, respectively. That is, if the electronic apparatus 100 moves to the right side, the actual object may move to a left direction which is an opposite direction from a moving direction of the electronic apparatus 100.

Conversely, if the electronic apparatus 100 moves to the right side, a ghost object at a position 430-1 may move to a position 430-2 in the live view image. That is, if the electronic apparatus 100 moves to the right side, the ghost object may move to a right direction which is the same direction as the moving direction of the electronic apparatus 100.

Accordingly, the processor 140 may identify the ghost object by comparing the motion of the electronic apparatus 100 and the motion of each object.

In addition, the processor 140 may provide a guide message to a user for identification of the ghost object. For example, the processor 140 may provide, based on an area of a predetermined brightness or more being identified in the plurality of first live view images, a message such as “please shake the electronic apparatus” (or “please move the electronic apparatus”).

Alternatively, the processor 140 may provide, based on displaying the plurality of first live view images through the display 120, a message such as “please shake the electronic apparatus”.

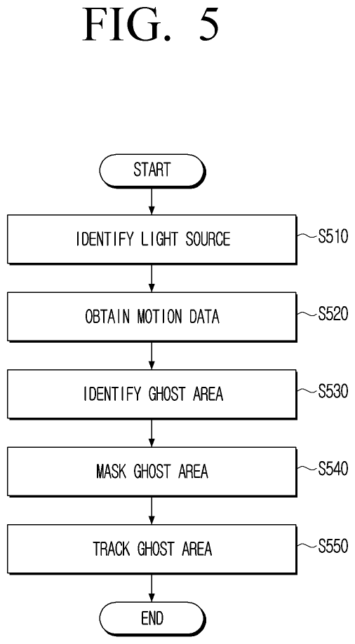

FIG. 5 to FIG. 10 are diagrams illustrating a method for tracking a ghost area according to an embodiment of the disclosure.

First, the processor 140 may identify a light source (S510). For example, the processor 140 may display the plurality of first live view images obtained through the camera 110 through the display 120, and identify an area of a predetermined brightness or more in the plurality of first live view images.

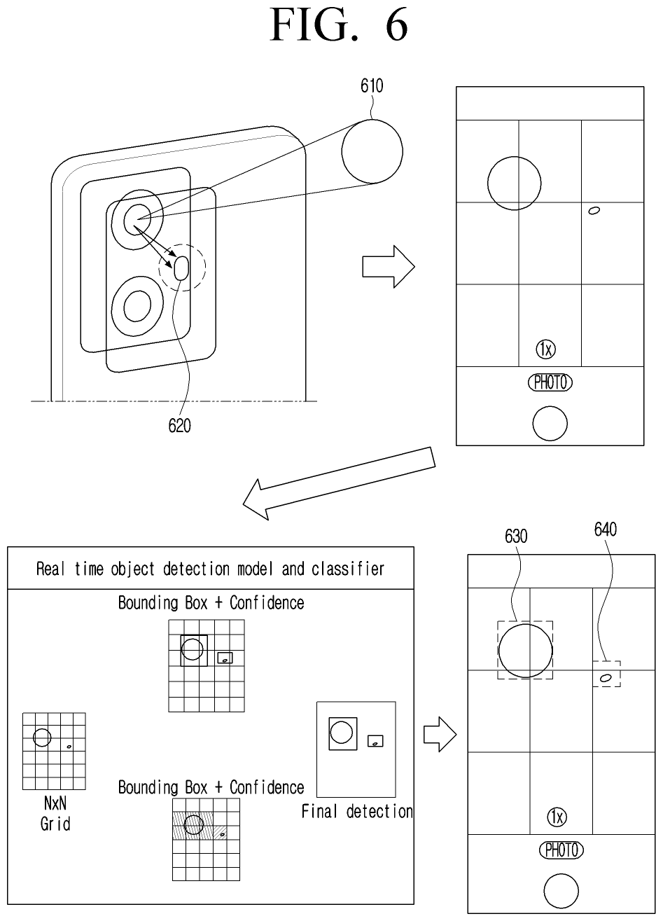

In an example, the processor 140 may capture, as shown at an upper left side of FIG. 6, a light source 610 and a ghost source 620, and display a live view image as shown at an upper right side of FIG. 6 through the display 120.

The processor 140 may analyze the live view image through an object identifying model as shown at a lower left side of FIG. 6 and identify a first area 630 corresponding to the light source 610 and a second area 640 corresponding to the ghost source 620 in the live view image as shown at a lower right side of FIG. 6. Here, the object identifying model may be, as a model that identifies areas of a predetermined brightness or more from an image, a rule-based model or a neural network model. The object identifying model may be a model that identifies two areas which are similar in form. In an example, the object identifying model may be a model that identifies the first area 630 of the predetermined brightness or more, and performs at least one from among rotation or scaling for the first area 630 and identifies the second area 640 that corresponds thereto. Alternatively, the object identifying model may identify a plurality of areas of a predetermined brightness or more, and identify the first area 630 and the second area 640 by comparing the forms of the two areas from among the plurality of areas.

However, the embodiment is not limited thereto, and the processor 140 may identify the first area 630 and the second area 640 through various methods.

However, the processor 140 may identify the first area 630 and the second area 640 in the live view image as areas in a rectangular form. For example, the light source 610 and the ghost source 620 in the live view image may each be in a circular form, but the processor 140 may identify the first area 630 and the second area 640 in the rectangular form that includes the circular forms respectively. That is, the first area 630 and the second area 640 may not only include the light source 610 and the ghost source 620, respectively, but also further include a surrounding area of the light source 610 and a surrounding area of the ghost source 620. Then, the processor 140 may remove the ghost source 620 of the second area 640 through a mask corresponding to the second area 640, and the mask used herein may be a mask for removing the ghost source 620 through a surrounding pixel value(s) of the ghost source 620. The mask may be generated based on the surrounding pixel value(s) of the ghost source 620.

However, the embodiment is not limited thereto, and the processor 140 may identify the first area 630 and the second area 640 respectively corresponding to the light source 610 and the ghost source 620. That is, the first area 630 and the second area 640 may include only the light source 610 and only the ghost source 620, respectively. In this case, the processor 140 may remove the ghost source 620 of the second area 640 through a mask corresponding to an area bigger than the second area 640, and the mask used herein may be a mask for removing the ghost source 620 through the surrounding pixel value(s) of the ghost source 620. The mask may be generated based on the surrounding pixel value(s) of the ghost source 620.

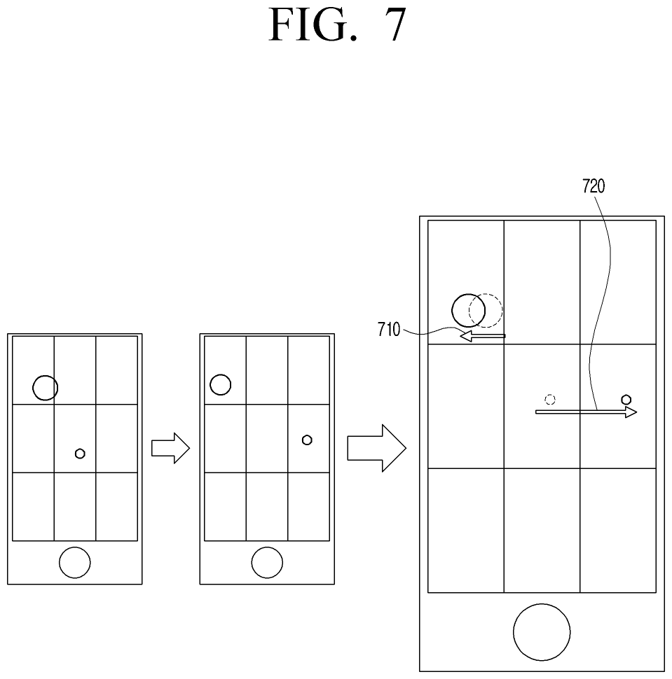

The processor 140 may obtain motion data based on the light source being identified (S520). For example, the processor 140 may identify, as shown in FIG. 7, a first motion 710 of a first area and a second motion 720 of a second area from a plurality of live view images according to movement of the electronic apparatus 100. In an example, the processor 140 may identify displacement by pixels of the first area in two live view images as the first motion 710, and identify displacement by pixels of the second area in the two live view images as the second motion 720. As described above, the moving direction of the light source and the moving direction of the ghost source may be opposite to each other, based on the movement of the electronic apparatus 100.

In addition, the processor 140 may identify the third motion of the electronic apparatus 100 according to the movement of the electronic apparatus 100. Here, the third motion may be three-dimensional motion data, and the processor 140 may convert the third motion to two-dimensional data, and compare the first motion and the second motion with the converted third motion. In an example, the processor 140 may convert the three-dimensional motion data to the two-dimensional motion data using a method for projecting the third motion on a plane parallel to the display 120 of the electronic apparatus 100. However, the embodiment is not limited thereto, and the processor 140 may convert the three-dimensional motion data to the two-dimensional motion data using various methods.

The processor 140 may identify the ghost area based on each motion, that is, the first motion of the first area and the second motion of the second area (S530). Here, the ghost area may be the area subject to removal. For example, the processor 140 may identify one from among the first area and the second area as the area subject to removal based on the moving direction of the electronic apparatus 100. In an example, the processor 140 may identify an area having a motion in the same direction as the moving direction of the electronic apparatus 100 as the area subject to removal.

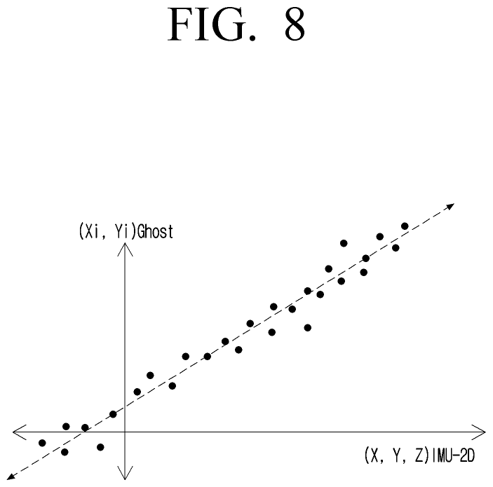

Alternatively, the processor 140 may identify the area subject to removal by taking into further consideration not only the moving direction of each motion, but also whether the movement distance by a time period is proportionate to the motion of the electronic apparatus 100. For example, the processor 140 may compare one from among the motions of the first area and the second area with the third motion through regression analysis, and identify, as shown in FIG. 8, an area where a proportionate relationship is established as the area subject to removal as the ghost area.

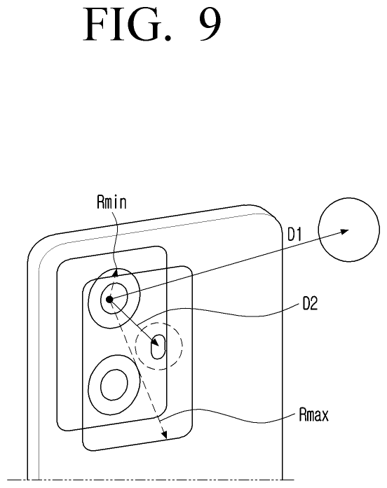

Alternatively, the processor 140 may identify the area subject to removal by taking into further consideration the distance to the object. For example, the processor 140 may identify, as shown in FIG. 9, a first distance D1 to the light source corresponding to the first area and a second distance D2 to the ghost source corresponding to the second area, identify, from among the first distance D1 and the second distance D2, the second distance D2 between a minimum distance Rmin from the lens to the cover glass and a maximum distance Rmax from the lens to the cover glass, and identify the second area corresponding to the second distance D2 as the area subject to removal.

Alternatively, the processor 140 may identify the area subject to removal based on at least one from among a brightness and a size of the first area and the second area. For example, the processor 140 may identify an area with a low brightness from among the first area and the second area as the area subject to removal. Alternatively, the processor 140 may identify an area with a small size from among the first area and the second area as the area subject to removal.

In the above, a method for identifying the area subject to removal has been described using various methods has been described, and each method may be combined in any various way.

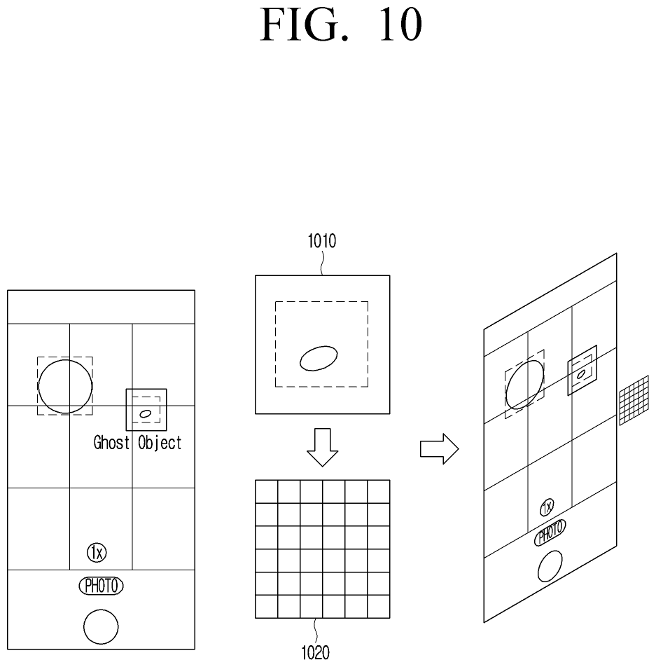

The processor 140 may perform, based on the area subject to removal being identified, masking of the area subject to removal (ghost area) (S540). For example, the processor 140 may perform, based on the area subject to removal being identified, image processing on an area corresponding to the area subject to removal, based on the at least one surrounding pixel value in the plurality of second live view images, after identification of the area subject to removal is completed. In an example, the processor 140 may identify, based on the area subject to removal being identified in the first live view image as shown in FIG. 10, an area corresponding to the area subject to removal in the second live view image directly after the first live view image based on the third motion of the electronic apparatus 100. That is, the processor 140 may identify an area corresponding to the area subject to removal in the second live view image by predicting a degree of movement of the area subject to removal based on the third motion of the electronic apparatus 100 during a time from the first live view image to the second live view image. The processor 140 may generate, based on an area 1010 corresponding to the area subject to removal being identified in the second live view image, an object removing mask 1020 to correspond thereto, and remove a ghost object from the area 1010 corresponding to the area subject to removal by using the object removing mask 1020.

However, the embodiment is not limited thereto, and the processor 140 may guide the user on the ghost area before removing the ghost area. For example, the processor 140 may display, based on the ghost area being identified as the area subject to removal, a focus indicating the ghost area. In addition, the processor 140 may provide a guide message guiding that the ghost area can be removed through the displayed focus. The processor 140 may perform, based on the user selecting the focus, a ghost area masking operation.

The processor 140 may track, based on the plurality of second live view images being displayed continuously, an area (or ghost area) corresponding to the area subject to removal from each second live view image based on the third motion of the electronic apparatus (S550). The processor 140 may track an area corresponding to the area subject to removal from each second live view image, and perform image processing to remove the ghost object in the area subject to removal from each second live view image.

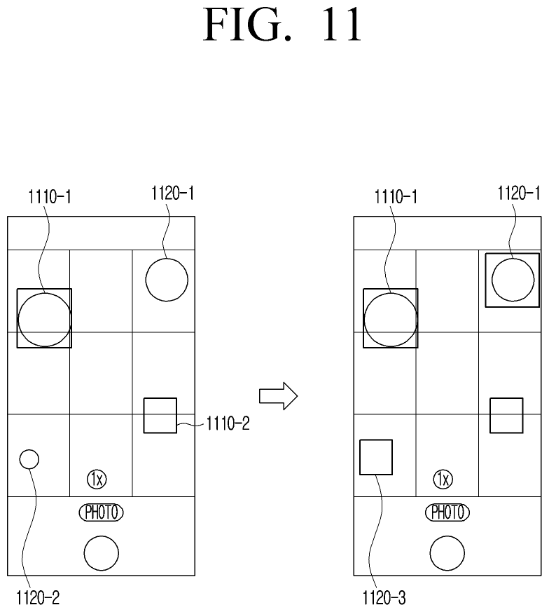

FIG. 11 is a diagram illustrating a method for identifying an additional ghost area according to an embodiment of the disclosure.

The processor 140 may perform image processing to remove a ghost object from a live view image. For example, the processor 140 may identify a first light source 1110-1 and a first ghost area corresponding to a ghost source (which is due to rays emitted from the first light source 1110-1), and remove the first ghost area through a first object removing mask 1110-2 as shown in a left side of FIG. 11.

The processor 140 may predict positions of the area subject to removal in following live view images based on the third motion of the electronic apparatus 100, and consecutively remove the first ghost area from the following live view images through the first object removing mask 1110-2.

In addition, the processor 140 may identify areas of a predetermined brightness or more in following live view images. For example, the processor 140 may identify a second light source 1120-1 and a second ghost area 1120-2 corresponding to a ghost source (which is due to rays emitted from the second light source 1120-1) as in a right side of FIG. 11. In an embodiment, an identification method of the second light source 1120-1 and the second ghost area 1120-2 may be same as the identification method of the first light source 1110-1 and the first ghost area.

The processor 140 may remove, through a method same as the removal method of the first ghost area, the second ghost area through a second object removing mask 1120-3 as in the right side of FIG. 11.

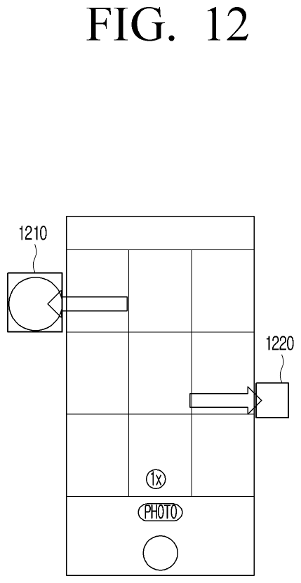

FIG. 12 is a diagram illustrating an operation of a ghost area being removed according to an embodiment of the disclosure.

The processor 140 may predict a position of the area subject to removal in a live view image based on the third motion of the electronic apparatus 100. In addition, the processor 140 may predict a position of a light source in the live view image based on the third motion of the electronic apparatus 100. The processor 140 may stop the prediction operation when a light source 1210 and an area subject to removal 1220 is identified as being outside the live view image based on the third motion of the electronic apparatus 100 as shown in FIG. 12.

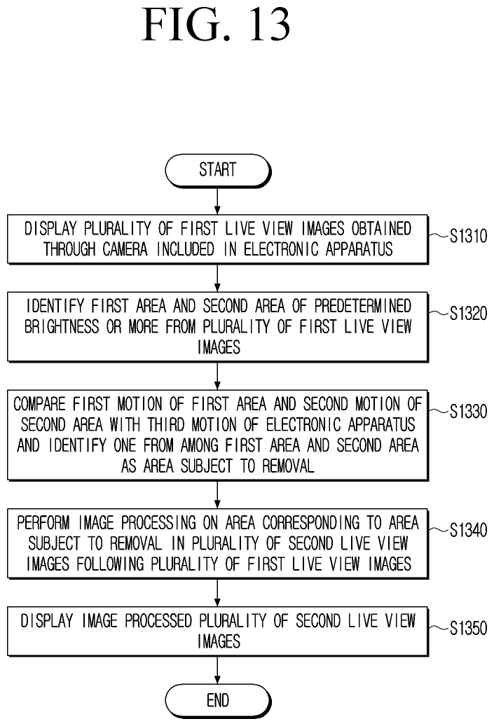

FIG. 13 is a flowchart illustrating a control method of an electronic apparatus according to an embodiment of the disclosure.

First, a plurality of first live view images obtained through a camera included in the electronic apparatus may be displayed (S1310). Then, a first area and a second area of a predetermined brightness or more may be identified in the plurality of first live view images (S1320). Then, a first motion of the first area and a second motion of the second area may be compared with a third motion of the electronic apparatus and one area from among the first area and the second area may be identified as the area subject to removal (S1330). Then, image processing may be performed on an area corresponding to the area subject to removal in the plurality of second live view images following (or later obtained than) the plurality of first live view images (S1340). Then, the image processed plurality of second live view images may be displayed (1350).

In addition, the identifying as the area subject to removal (S1330) may include identifying, from among the first motion and the second motion, an area of which a direction of a motion is same as a direction of the third motion and of which a movement distance by a time period is proportionate with that of the third motion, as the area subject to removal.

Further, the camera may include the lens and the cover glass that comes in contact with the lens, and the identifying as the area subject to removal (S1330) may include identifying the first distance to the first object that corresponds to the first area and the second distance to the second object that corresponds to the second area, and identifying, from among the first area and the second area, the area subject to removal based on the first distance or the second distance being between the minimum distance from the lens to the cover glass and the maximum distance from the lens to the cover glass.

In addition, one object from among the first object and the second object may be a light source outside of the electronic apparatus, and the other object from among the first object and the second object may correspond to an area where light, which is emitted from the light source, reflected by the lens, reaches the cover glass and is reflected by the cover glass, and reaches the lens, and the identifying as the area subject to removal (S1330) may include identifying the other object from among the first object and the second object as the area subject to removal.

Further, the performing image processing (S1340) may include performing image processing on an area corresponding to the area subject to removal in the plurality of second live view images following (or later obtained than) the plurality of first live view images based on the at least one surrounding pixel value of the area corresponding to the area subject to removal.

In addition, determining a position of the area corresponding to the area subject to removal in the plurality of second live view images based on the third motion may be further included.

Further, identifying, based on the determined position being outside of the plurality of second live view images, the third area of the predetermined brightness or more in the plurality of second live view images may be further included.

In addition, the identifying the first area and the second area (S1320) may include identifying one area from among the first area and the second area, as the area subject to removal, based on a form of at least one of the first area and the second area.

Further, the third motion may be three-dimensional motion data, and the identifying as the area subject to removal (S1330) may include converting the third motion to two-dimensional motion data, and identifying one area from among the first area and the second area as the area subject to removal by comparing the first motion and the second motion with the converted third motion.

In addition, performing, based on the capture command being received, image processing on an area corresponding to the area subject to removal in the live view image corresponding to the capture command, and storing the image processed live view image may be further included.

According to the various embodiments of the disclosure as described above, the electronic apparatus may provide the live view image in which the ghost object is removed by performing image processing on the area subject to removal based on the motion of the area of the predetermined brightness or more and the motion of the electronic apparatus.

In addition, because the electronic apparatus tracks the area subject to removal based on the motion of the electronic apparatus, the ghost object may also be removed from the video.

According to an embodiment of the disclosure, the various embodiments described above may be implemented with software including instructions stored in a machine-readable storage media (e.g., computer). The machine may call a stored instruction from a storage medium, and as an apparatus operable according to the called instruction, may include an electronic apparatus (e.g., electronic apparatus (A)) according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, ‘non-transitory’ may mean that the storage medium is tangible and does not include a signal only, and the term does not differentiate data being semi-permanently stored or being temporarily stored in the storage medium.

In addition, according to an embodiment of the disclosure, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or a memory of a relay server, or temporarily generated.

In addition, according to an embodiment of the disclosure, the various embodiments described above may be implemented in a recordable medium which is readable by a computer or a device similar to the computer using software, hardware, or a combination thereof. In some cases, embodiments described herein may be implemented by the processor itself. According to a software implementation, embodiments such as the procedures and functions described herein may be implemented with separate software modules. The respective software modules may perform one or more functions and operations described herein.

The computer instructions for performing processing operations in the devices according to the various embodiments described above may be stored in a non-transitory computer-readable medium. The computer instructions stored in this non-transitory computer-readable medium may cause a specific device to perform a processing operation in devices according to the various embodiments described above when executed by at least one processor of the specific device. The non-transitory computer-readable medium may refer to a medium that stores data semi-permanently rather than storing data for a very short time, such as a register, a cache, a memory, or the like, and is readable by a device. Specific examples of the non-transitory computer-readable medium may include, for example, and without limitation, a compact disc (CD), a digital versatile disc (DVD), a hard disc, a Blu-ray disc, a USB, a memory card, a ROM, and the like.

In addition, respective elements (e.g., a module or a program) according to the various embodiments described above may be formed of a single entity or a plurality of entities, and a portion of sub-elements from among the above-mentioned sub-elements may be omitted or other sub-elements may be further included in the various embodiments. Alternatively or additionally, a portion of elements (e.g., modules or programs) may be integrated into one entity to perform the same or similar functions performed by the respective corresponding elements prior to integration. Operations performed by a module, a program, or other element, in accordance with the various embodiments, may be executed sequentially, in parallel, repetitively, or in a heuristically manner, or at least a portion of the operations may be performed in a different order, omitted, or a different operation may be added.

While the disclosure has been illustrated and described with reference to example embodiments thereof, it will be understood that the example embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus, comprising:
a camera;
a display;
a sensor; and
at least one processor configured to:
control the display to display a plurality of first live view images obtained through the camera;
identify a first area and a second area, each having a predetermined brightness or greater, in the plurality of first live view images;
identify one area from among the first area and the second area as an area subject to removal by comparing a first motion of the first area and a second motion of the second area with a third motion of the electronic apparatus obtained through the sensor;
perform an image processing on an area corresponding to the area subject to removal in a plurality of second live view images, obtained after the plurality of first live view images through the camera; and
control the display to display the image processed plurality of second live view images.

2. The electronic apparatus of claim 1, wherein the at least one processor is configured to:
identify, from among the first area and the second area, an area of which a direction of a motion is same as a direction of the third motion and of which a movement distance by a time period is proportionate with that of the third motion, as the area subject to removal.

3. The electronic apparatus of claim 2, wherein the camera comprises:
a lens; and
a cover glass that comes in contact with the lens, and
wherein the at least one processor is further configured to:
identify a first distance to a first object that corresponds to the first area and a second distance to a second object that corresponds to the second area; and
identify, from among the first area and the second area, the area subject to removal based on the first distance or the second distance being between a minimum distance from the lens to the cover glass and a maximum distance from the lens to the cover glass.

4. The electronic apparatus of claim 3, wherein one object from among the first object and the second object is a light source outside of the electronic apparatus,
wherein another object from among the first object and the second object corresponds to an area where a light, which is emitted from the light source, reflected by the lens, reaches the cover glass and is reflected by the cover glass, and reaches the lens, and
wherein the at least one processor is configured to identify the another object from among the first object and the second object as the area subject to removal.

5. The electronic apparatus of claim 1, wherein the at least one processor is configured to:
perform the image processing on the area corresponding to the area subject to removal in the plurality of second live view images based on at least one surrounding pixel value of the area corresponding to the area subject to removal.

6. The electronic apparatus of claim 5, wherein the at least one processor is configured to:
determine a position of the area corresponding to the area subject to removal in the plurality of second live view images based on the third motion.

7. The electronic apparatus of claim 6, wherein the at least one processor is configured to:
identify, based on the determined position being outside of the plurality of second live view images, a third area having the predetermined brightness or greater in the plurality of second live view images.

8. The electronic apparatus of claim 1, wherein the at least one processor is configured to identify one area from among the first area and the second area, as the area subject to removal, based on a form of at least one of the first area and the second area.

9. The electronic apparatus of claim 1, wherein the third motion is three-dimensional motion data, and
wherein the at least one processor is configured to:
convert the third motion to two-dimensional motion data; and
identify one area from among the first area and the second area as the area subject to removal by comparing the first motion and the second motion with the converted third motion.

10. The electronic apparatus of claim 1, further comprising:
a user interface; and
a memory,
wherein the at least one processor is configured to:
perform, based on a command being received through the user interface, an image processing on an area corresponding to the area subject to removal in a live view image captured based on the command, and
store the image processed live view image in the memory.

11. A method of controlling an electronic apparatus, the method comprising:
displaying a plurality of first live view images obtained through a camera included in the electronic apparatus;
identifying a first area and a second area, each having a predetermined brightness or greater, in the plurality of first live view images;
identifying one area from among the first area and the second area as an area subject to removal by comparing a first motion of the first area and a second motion of the second area with a third motion of the electronic apparatus;
performing an image processing on an area corresponding to the area subject to removal from a plurality of second live view images obtained after the plurality of first live view images; and
displaying the image processed plurality of second live view images.

12. The method of claim 11, wherein the identifying as the area subject to removal comprises:
identifying, from among the first area and the second area, an area of which a direction of a motion is same as a direction of the third motion and of which a movement distance by a time period is proportionate with that of the third motion, as the area subject to removal.

13. The method of claim 12, wherein the camera comprises:
a lens; and
a cover glass that comes in contact with the lens, and
wherein the identifying as the area subject to removal comprises:
identifying a first distance to a first object that corresponds to the first area and a second distance to a second object that corresponds to the second area; and
identifying, from among the first area and the second area, the area subject to removal based on the first distance or the second distance being between a minimum distance from the lens to the cover glass and a maximum distance from the lens to the cover glass.

14. The method of claim 13, wherein one object from among the first object and the second object corresponds to a light source outside of the electronic apparatus,
wherein another object of the first object and the second object corresponds to an area where a light, which is emitted from the light source, reflected by the lens, reaches the cover glass and is reflected by the cover glass, and reaches the lens, and
wherein the identifying as the area subject to removal comprises identifying the another object from among the first object and the second object as the area subject to removal.

15. The method of claim 11, wherein the performing the image processing comprises:
performing the image processing on the area corresponding to the area subject to removal in the plurality of second live view images based on at least one surrounding pixel value of the area corresponding to the area subject to removal.
